(19) United States
(12) Patent Application Publication
(10) Pub. No.: US 2023/0134267 A1
(43) Pub. Date: May 4, 2023

(54) OPTICAL IMAGING LENS

(71) Applicant: Calin Technology Co., Ltd., Taichung City (TW)

(72) Inventors: YUNG-CHIEH TSENG, Taichung City (TW); PEI-LUN CHEN, Nantou County (TW); SHANG-RU YANG, Taichung City (TW)

(73) Assignee: Calin Technology Co., Ltd., Taichung City (TW)

(21) Appl. No.: 17/710,107

(22) Filed: Mar. 31, 2022

(30) Foreign Application Priority Data
Nov. 4, 2021 (TW) 110141151

(51) Int. Cl. G02B 9/10; G02B 13/18

(52) U.S. Cl. CPC G02B 9/10; G02B 13/18

(57) ABSTRACT

An optical imaging lens, in order from an object side to an image side along an optical axis, includes a first lens assembly with negative refractive power, an aperture, and a second lens assembly with positive refractive power. The first lens assembly includes a first lens having negative refractive power, a second lens having negative refractive power, and a third lens having positive refractive power. The second lens assembly includes a fourth lens having positive refractive power, a fifth lens having negative refractive power, and a sixth lens having positive refractive power. The optical imaging lens satisfies −0.6≤F/fg1≤−0.3 and 0.25≤F/fg2≤0.57, wherein F is a focal length of the optical imaging lens, fg1 is a focal length of the first lens assembly, and fg2 is a focal length of the second lens assembly, thereby achieving the effect of high image quality and low distortion.

### BACKGROUND OF THE INVENTION

### Technical Field

The present invention generally relates to an optical image capturing system, and more particularly to an optical imaging lens, which provides a better optical performance of high image quality and low distortion.

### Description of Related Art

In recent years, with advancements in portable electronic devices having camera functionalities, the demand for an optical image capturing system is raised gradually. The image sensing device of the ordinary photographing camera is commonly selected from a charge-coupled device (CCD) or a complementary metal-oxide-semiconductor sensor (CMOS Sensor). Besides, as advanced semiconductor manufacturing technology enables the minimization of the pixel size of the image sensing device, the development of the optical image capturing system towards the field of high pixels. Moreover, with the advancement in drones and driverless autonomous vehicles, Advanced Driver Assistance System (ADAS) plays an important role, collecting environmental information through various lenses and sensors to ensure the driving safety of the driver. Furthermore, as the image quality of the automotive lens changes with the temperature of an external application environment, the temperature requirements of the automotive lens also increase. Therefore, the requirement for high imaging quality is rapidly raised.

Good imaging lenses generally have the advantages of low distortion, high resolution, etc. In practice, small size and cost must be considered. Therefore, it is a big problem for designers to design a lens with good imaging quality under various constraints.

### BRIEF SUMMARY OF THE INVENTION

In view of the reasons mentioned above, the primary objective of the present invention is to provide an optical imaging lens that provides a better optical performance of high image quality and low distortion.

The present invention provides an optical imaging lens, in order from an object side to an image side along an optical axis, including a first lens assembly, an aperture, and a second lens assembly, wherein the first lens assembly has negative refractive power and includes in order along the optical axis from the object side to the image side, a first lens, a second lens, and a third lens. The first lens has negative refractive power. The second lens has negative refractive power. An object-side surface, an image-side surface, or both of the object-side surface and the image-side surface of the second lens are aspheric surfaces. The third lens has positive refractive power. An object-side surface, an image-side surface, or both of the object-side surface and the image-side surface of the third lens are aspheric surfaces. The second lens assembly has positive refractive power and includes, in order along the optical axis from the object side to the image side, a fourth lens, a fifth lens, and a sixth lens, wherein the fourth lens has positive refractive power. The fifth lens has negative refractive power. An object-side surface, an image-side surface, or both of the object-side surface and the image-side surface of the fifth lens are aspheric surfaces. The sixth lens has positive refractive power. An object-side surface, an image-side surface, or both of the object-side surface and the image-side surface of the sixth lens are aspheric surfaces. The optical imaging lens satisfies: −0.6≤F/fg1≤−0.3; F is a focal length of the optical imaging lens and fg1 is a focal length of the first lens assembly.

The present invention further provides an optical imaging lens, in order from an object side to an image side along an optical axis, includes a first lens assembly, an aperture, and a second lens assembly, wherein the first lens assembly has negative refractive power and includes, in order along the optical axis from the object side to the image side, a first lens, a second lens, and a third lens. The first lens has negative refractive power. The second lens has negative refractive power. An object-side surface, an image-side surface, or both of the object-side surface and the image-side surface of the second lens are aspheric surfaces. The third lens has positive refractive power. An object-side surface, an image-side surface, or both of the object-side surface and the image-side surface of the third lens are aspheric surfaces. The second lens assembly has positive refractive power and includes, in order along the optical axis from the object side to the image side, a fourth lens, a fifth lens, and a sixth lens, wherein the fourth lens has positive refractive power; the fifth lens has negative refractive power. An object-side surface, an image-side surface, or both of the object-side surface and the image-side surface of the fifth lens are aspheric surfaces. The sixth lens has positive refractive power. An object-side surface, an image-side surface, or both of the object-side surface and the image-side surface of the sixth lens are aspheric surfaces. The optical imaging lens satisfies: 0.25≤F/fg2≤0.57; F is a focal length of the optical imaging lens and fg2 is a focal length of the second lens assembly.

With the aforementioned design, the optical imaging lens has a total of six lenses to form five groups of optical assemblies, and defines the first lens assembly and the second lens assembly. In addition, since the optical imaging lens satisfies −0.6≤F/fg1≤−0.3 and 0.25≤F/fg2≤0.57, which could effectively improve a chromatic aberration of the optical imaging lens and achieve the effect of high image quality.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1A is a schematic view of the optical imaging lens according to a first embodiment of the present invention;

FIG. 1B is a diagram showing the astigmatic field curvature of the optical imaging lens according to the first embodiment of the present invention;

FIG. 1C is a diagram showing the distortion of the optical imaging lens according to the first embodiment of the present invention;

FIG. 2A is a schematic view of the optical imaging lens according to a second embodiment of the present invention;

FIG. 2B is a diagram showing the astigmatic field curvature of the optical imaging lens according to the second embodiment of the present invention;

FIG. 2C is a diagram showing the distortion of the optical imaging lens according to the second embodiment of the present invention;

FIG. 3A is a schematic view of the optical imaging lens according to a third embodiment of the present invention;

FIG. 3B is a diagram showing the astigmatic field curvature of the optical imaging lens according to the third embodiment of the present invention; and

FIG. 3C is a diagram showing the distortion of the optical imaging lens according to the third embodiment of the present invention.

### DETAILED DESCRIPTION OF THE INVENTION

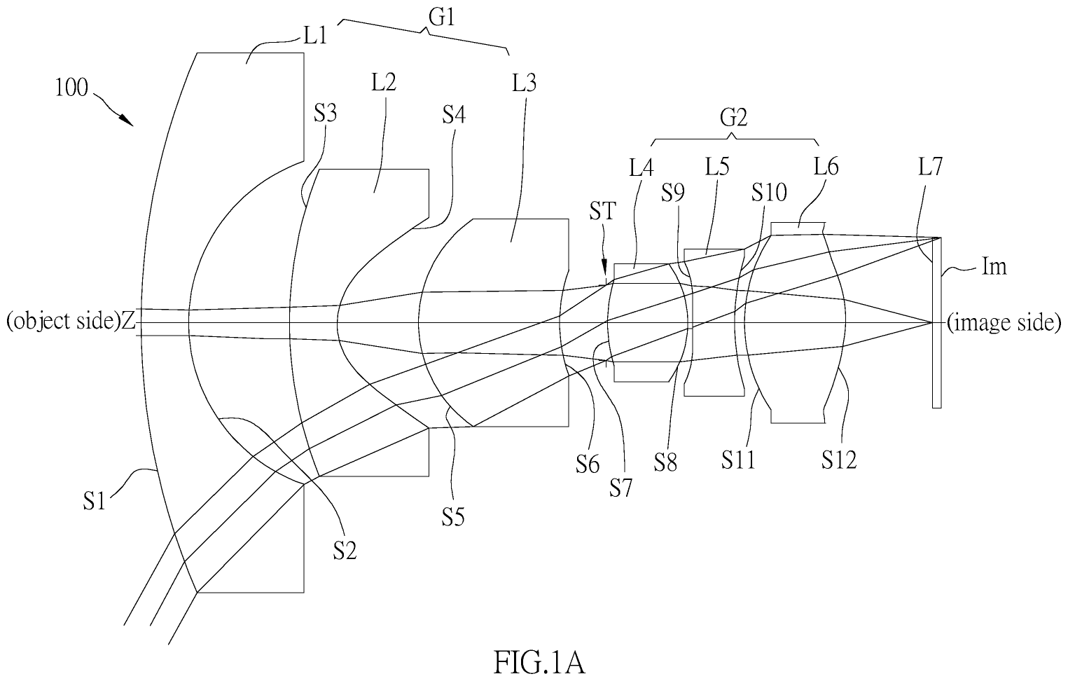

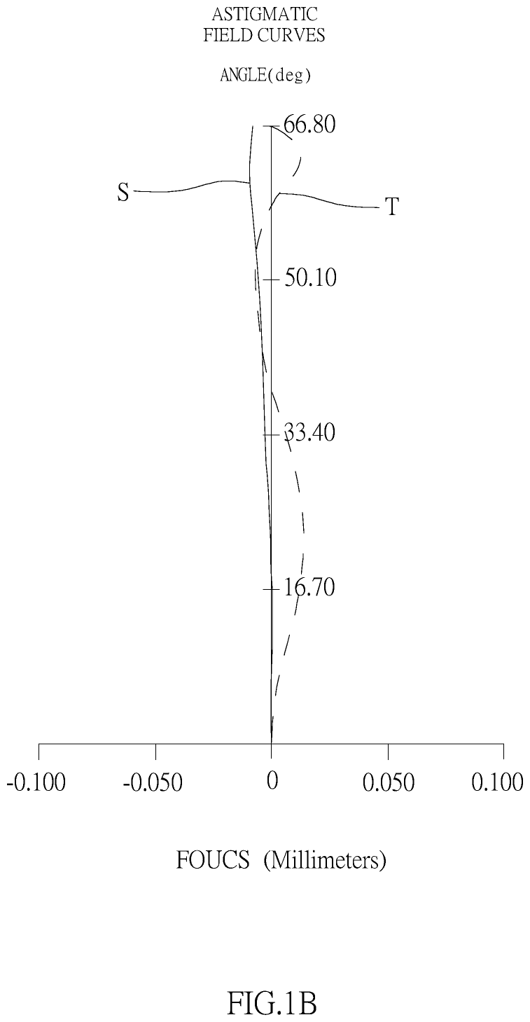

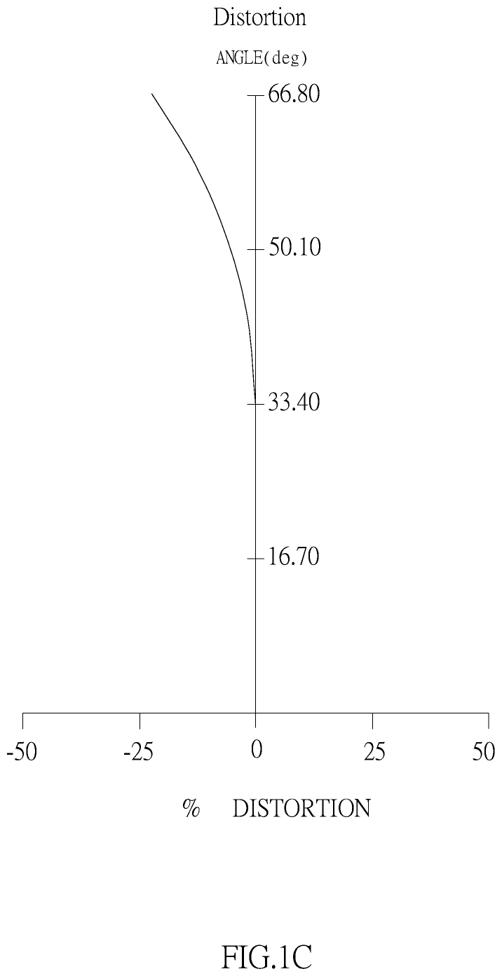

An optical imaging lens 100 according to a first embodiment of the present invention is illustrated in FIG. 1A, which includes, in order along an optical axis Z from an object side to an image side, a first lens assembly G1, an aperture ST, and a second lens assembly G2. In the current embodiment, the first lens assembly G1 has negative refractive power and includes, in order along an optical axis Z from an object side to an image side, a first lens L1, a second lens L2, and a third lens L3; the second lens assembly G2 has positive refractive power and includes, in order along an optical axis Z from an object side to an image side, a fourth lens L4, a fifth lens L5, and a sixth lens L6.

The first lens L1 is a negative meniscus with negative refractive power, wherein an object-side surface S1 of the first lens L1 is a convex surface toward the object side, and an image-side surface S2 of the first lens L1 is a concave surface toward the image side. As shown in FIG. 1A, both of the object-side surface S1 and the image-side surface S2 of the first lens L1 are spherical surfaces; a surface of the first lens L1 toward the object side is convex to form the object-side surface S1, and a part of a surface of the first lens L1 toward the image side is recessed to form the image-side surface S2, and the optical axis Z passes through the object-side surface S1 and the image-side surface S2 of the first lens L1.

The second lens L2 is a negative meniscus with negative refractive power, wherein an object-side surface S3 of the second lens L2 is a convex surface toward the object side, and an image-side surface S4 of the second lens L2 is a concave surface toward the image side; the object-side surface S3, the image-side surface S4, or both of the object-side surface S3 and the image-side surface S4 of the second lens L2 are aspheric surfaces. As shown in FIG. 1A, both of the object-side surface S3 and the image-side surface S4 of the second lens L2 are aspheric surfaces; a surface of the second lens L2 toward the object side is convex to form the object-side surface S3, and a part of a surface of the second lens L2 toward the image side is recessed to form the image-side surface S4, and the optical axis Z passes through the object-side surface S3 and the image-side surface S4 of the second lens L2.

The third lens L3 is a positive meniscus with positive refractive power, wherein an object-side surface S5 of the third lens L3 is a convex surface toward the object side, and an image-side surface S6 of the third lens L3 is a concave surface toward the image side; the object-side surface S5, the image-side surface S6, or both of the object-side surface S5 and the image-side surface S6 of the third lens L3 are aspheric surfaces. As shown in FIG. 1A, both of the object-side surface S5 and the image-side surface S6 of the third lens L3 are aspheric surfaces; a surface of the third lens L3 toward the object side is convex to form the object-side surface S5, and a part of a surface of the third lens L3 toward the image side is recessed to form the image-side surface S6, and the optical axis Z passes through the object-side surface S5 and the image-side surface S6 of the third lens L3.

The fourth lens L4 is a biconvex lens (i.e., both of an object-side surface S7 of the fourth lens L4 and an image-side surface S8 of the fourth lens L4 are convex surfaces) with positive refractive power. As shown in FIG. 1A, a part of a surface of the fourth lens L4 toward the object side is convex to form the object-side surface S7, and a surface of the fourth lens L4 toward the image side is convex to form the image-side surface S8, and the optical axis Z passes through the object-side surface S7 and the image-side surface S8 of the fourth lens L4.

The fifth lens L5 is a biconcave lens (i.e., both of an object-side surface S9 of the fifth lens L5 and an image-side surface S10 of the fifth lens L5 are concave surfaces) with negative refractive power; the object-side surface S9, the image-side surface S10, or both of the object-side surface S9 and the image-side surface S10 of the fifth lens L5 are aspheric surfaces. As shown in FIG. 1A, both of the object-side surface S9 and the image-side surface S10 of the fifth lens L5 are aspheric surfaces; a part of a surface of the fifth lens L5 toward the object side is recessed to form the object-side surface S9, and a part of a surface of the fifth lens L5 toward the image side is recessed to form the image-side surface S10, and the optical axis Z passes through the object-side surface S9 and the image-side surface S10 of the fifth lens L5.

The sixth lens L6 is a biconvex lens (i.e., both of an object-side surface S11 of the sixth lens L6 and an image-side surface S12 of the sixth lens L6 are convex surfaces) with positive refractive power; the object-side surface S11, the image-side surface S12, or both of the object-side surface S11 and the image-side surface S12 of the sixth lens L6 are aspheric surfaces. As shown in FIG. 1A, both of the object-side surface S11 and the image-side surface S12 of the sixth lens L6 are aspheric surfaces; a part of a surface of the sixth lens L6 toward the object side is convex to form the object-side surface S11, and a part of a surface of the sixth lens L6 toward the image side is convex to form the image-side surface S12 with two inflection points, and the optical axis Z passes through the object-side surface S11 and the image-side surface S12 of the sixth lens L6.

Additionally, the optical imaging lens 100 further includes an infrared filter L7 disposed between the sixth lens L6 and an image plane Im of the optical imaging lens 100 and is closer to the image plane Im than the image-side surface S12 of the sixth lens L6, thereby filtering out excess infrared rays in an image light passing through the optical imaging lens 100 to improve imaging quality.

In order to keep the optical imaging lens 100 in good optical performance and high imaging quality, the optical imaging lens 100 further satisfies:

−0.25≤F/f1≤−0.09; −0.65≤F/f2≤−0.3; 0.1≤F/f3≤0.35; (1)

−0.6≤F/fg1≤−0.3; (2)

0.1≤fg1/f1≤0.5; 0.5≤fg1/f2≤1.5; −0.7≤fg1/f3≤−0.2; (3)

0.3≤F/f4≤0.65; −0.56≤F/f5≤−0.25; 0.3≤F/f6≤0.7; (4)

0.25≤F/fg2≤0.57; (5)

0.5≤fg2/f4≤1.2; −1.4≤fg2/f5≤−0.5; 0.7≤fg2/f6≤1.3; (6)

0.5≤|fg2/fg1|≤2.5; (7)

nd4≤1.65; |V4−V5|≤60; 0.9≤|f4/L4R2|≤2; (8)

−27≤HFoV/fg1≤−12; 10<HFoV/fg2≤17; (9)

wherein F is a focal length of the optical imaging lens 100; f1 is a focal length of the first lens L1; f2 is a focal length of the second lens L2; f3 is a focal length of the third lens L3; f4 is a focal length of the fourth lens L4; f5 is a focal length of the fifth lens L5; f6 is a focal length of the sixth lens L6; fg1 is a focal length of the first lens assembly G1; fg2 is a focal length of the second lens assembly G2; nd4 is a refractive index of the fourth lens L4; V4 is an Abbe number of the fourth lens L4; V5 is an Abbe number of the fifth lens L5; L4R2 is a radius of curvature of the image-side surface S8 of the fourth lens L4.

Parameters of the optical imaging lens 100 of the first embodiment of the present invention are listed in following Table 1, including the focal length F of the optical imaging lens 100 (also called an effective focal length (EFL)), a F-number (Fno), a maximal field of view (HFOV), a radius of curvature (R) of each lens, a distance (D) between each surface and the next surface on the optical axis Z, a refractive index (Nd) of each lens, an Abbe number (Vd) of each lens, the focal length of each lens, wherein a unit of the focal length, the radius of curvature, and the distance is millimeter (mm).

TABLE 1
F = 1.72 mm; Fno = 2.0; HFOV = 65 deg

| | | | | | | Cemented | |
|---|---|---|---|---|---|---|---|
| | | | | | Focal | focal | |
| Surface | R(mm) | D(mm) | Nd | Vd | length | length | Note |
| S1 | 21.51 | 1.50 | 1.62 | 60.29 | −12.02 | 21.51 | L1 |
| S2 | 5.40 | 3.14 | | | | 5.40 | |
| S3 | 13.63 | 1.50 | 1.52 | 56.46 | −4.12 | 13.63 | L2 |
| S4 | 1.80 | 2.50 | | | | 1.80 | |
| S5 | 3.88 | 4.42 | 1.64 | 23.53 | 8.93 | 3.88 | L3 |
| S6 | 6.61 | 1.44 | | | | 6.61 | |
| ST | | 0.10 | | | | | ST |
| S7 | 5.50 | 2.50 | 1.50 | 81.55 | 4.41 | 5.50 | L4 |
| S8 | −3.10 | 0.15 | | | | −3.10 | |
| S9 | −18.91 | 1.30 | 1.64 | 23.53 | −4.93 | −18.91 | L5 |
| S10 | 3.92 | 0.30 | | | | 3.92 | |
| S11 | 3.04 | 3.16 | 1.52 | 56.46 | 3.94 | 3.04 | L6 |
| S12 | −4.19 | 2.70 | | | | −4.19 | |
| S13 | Infinity | 0.30 | 1.52 | 64.17 | | Infinity | Infrared |
| | | | | | | | filter L7 |
| S14 | Infinity | 0.00 | | | | Infinity | |
| Im | Infinity | | | | | Infinity | Im |

It can be seen from Table 1 that, in the current embodiment, the focal length F of the optical imaging lens 100 is 1.72 mm, and the Fno is 2.0, and the HFOV is 65 degrees, wherein f1=−12.02 mm; f2=−4.12 mm; f3=8.93 mm; f4=4.41 mm; L4R2=−3.10 mm; nd4=1.50; V4=81.55; f5=−4.93 mm; V5=23.53; f6=3.94 mm; fg1=−3.88 mm; fg2=4.40 mm.

Additionally, based on the above detailed parameters, detailed values of the aforementioned conditional formula in the first embodiment are as follows:

F/f1=−0.14; F/f2=−0.42; F/f3=0.19; (1)

F/fg1=−0.44; (2)

fg1/f1=0.32; fg1/f2=0.94; fg1/f3=−0.44; (3)

F/f4=0.39; F/f5=−0.35; F/f6=0.44; (4)

F/fg2=0.39; (5)

fg2/f4=1; fg2/f5=−0.89; fg2/f6=1.12; (6)

|fg2/fg1|=1.13; (7)

nd4=1.5; |V4−V5|=58.02; |f4/L4R2|=1.42; (8)

HFoV/fg1=−16.74; HFoV/fg2=14.78. (9)

With the aforementioned design, the first lens assembly G1 and the second lens assembly G2 satisfy the aforementioned conditions (1) to (9) of the optical imaging lens 100.

Moreover, an aspheric surface contour shape Z of each of the object-side surface S3 of the second lens L2, and the image-side surface S4 of the second lens L2, and the object-side surface S9 of the fifth lens L5, and the image-side surface S10 of the fifth lens L5 of the optical imaging lens 100 according to the first embodiment could be obtained by following formula:

$$Z = \frac{{ch}^{2}}{1 + \sqrt{1 - ( 1 + k ) {c}^{2} {h}^{2}}} + {A}_{4} {h}^{4} + {A}_{6} {h}^{6} + {A}_{8} {h}^{8} + {A}_{10} {h}^{10} + {A}_{12} {h}^{12} + {A}_{14} {h}^{14} + {A}_{16} {h}^{16}$$

wherein Z is aspheric surface contour shape; c is reciprocal of radius of curvature; h is half the off-axis height of the surface; k is conic constant; A4, A6, A8, A10, A12, A14, and A16 respectively represents different order coefficient of h.

The conic constant k of each of the object-side surface S3 of the second lens L2, and the image-side surface S4 of the second lens L2, and the object-side surface S9 of the fifth lens L5, and the image-side surface S10 of the fifth lens L5 of the optical imaging lens 100 according to the first embodiment and the different order coefficient of A4, A6, A8, A10, A12, A14, and A16 are listed in following Table 2 and Table 3:

TABLE 2

| Surface | S3 | S4 | S5 | S6 |
|---|---|---|---|---|
| k | −9.00E+01 | −1.41E+00 | −7.06E−01 | 1.17E+01 |
| A4 | 5.19E−03 | 6.56E−03 | −4.35E−04 | 1.69E−03 |
| A6 | −4.68E−04 | 1.56E−03 | 7.07E−04 | 2.09E−05 |
| A8 | 2.30E−05 | −5.75E−04 | −1.33E−04 | 1.29E−03 |
| A10 | −6.64E−07 | 7.35E−05 | 1.72E−05 | −1.12E−03 |
| A12 | 1.07E−08 | −4.35E−06 | −1.06E−06 | 4.24E−04 |
| A14 | −7.84E−11 | 9.79E−08 | 2.64E−08 | −6.23E−05 |
| A16 | 0 | 0 | 0 | 0 |

TABLE 3

| Surface | S9 | S10 | S11 | S12 |
|---|---|---|---|---|
| k | 7.17E+01 | −1.68E+01 | −8.39E+00 | −2.70E+00 |
| A4 | −1.13E−02 | −2.36E−03 | 3.44E−03 | 1.35E−03 |
| A6 | 1.88E−03 | −8.26E−04 | −1.33E−03 | −2.95E−04 |
| A8 | −7.31E−04 | 5.08E−04 | 3.90E−04 | 3.71E−05 |
| A10 | 1.72E−04 | −1.06E−04 | −4.76E−05 | −3.57E−06 |
| A12 | −3.28E−05 | 9.16E−06 | 2.89E−06 | 9.49E−07 |
| A14 | 2.68E−06 | −3.09E−07 | −7.04E−08 | −4.12E−08 |
| A16 | 0 | 0 | 0 | 0 |

Taking optical simulation data to verify the imaging quality of the optical imaging lens 100, wherein FIG. 1B is a diagram showing the astigmatic field curves according to the first embodiment; FIG. 1C is a diagram showing the distortion according to the first embodiment. The graphics shown in FIG. 1B and FIG. 1C are within a standard range. In this way, the optical imaging lens 100 of the first embodiment could effectively enhance image quality and lower a distortion thereof

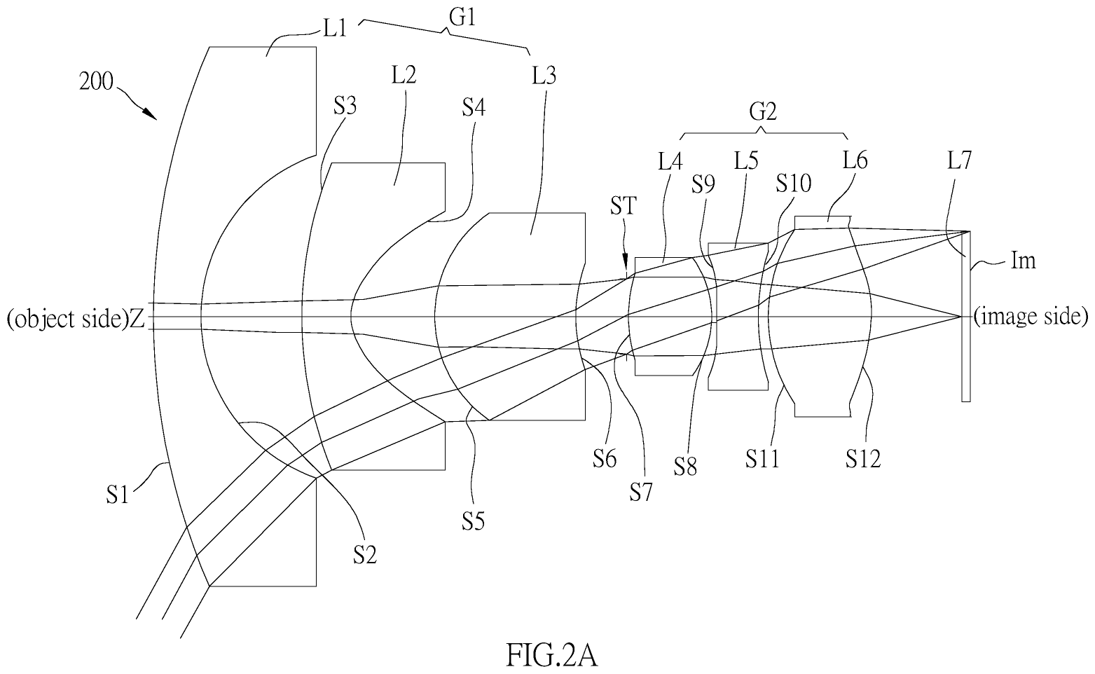

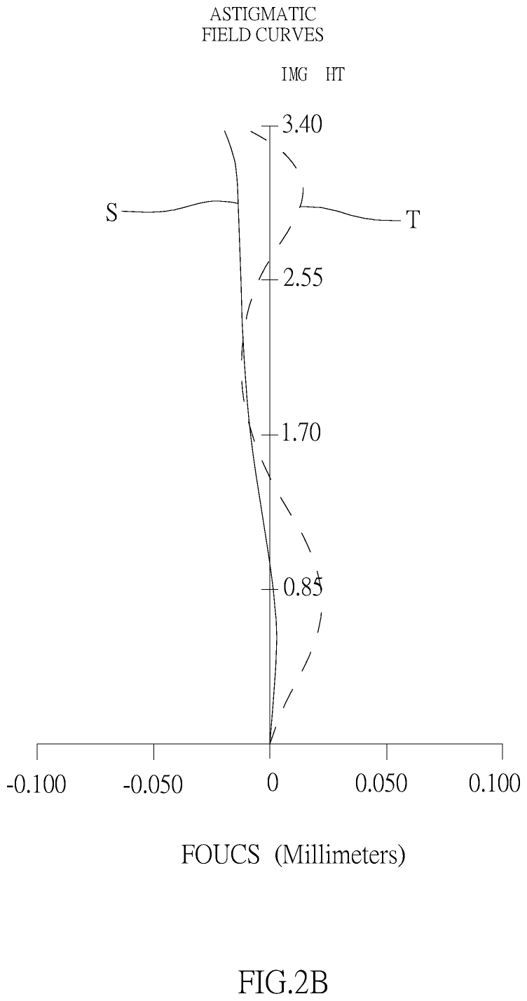

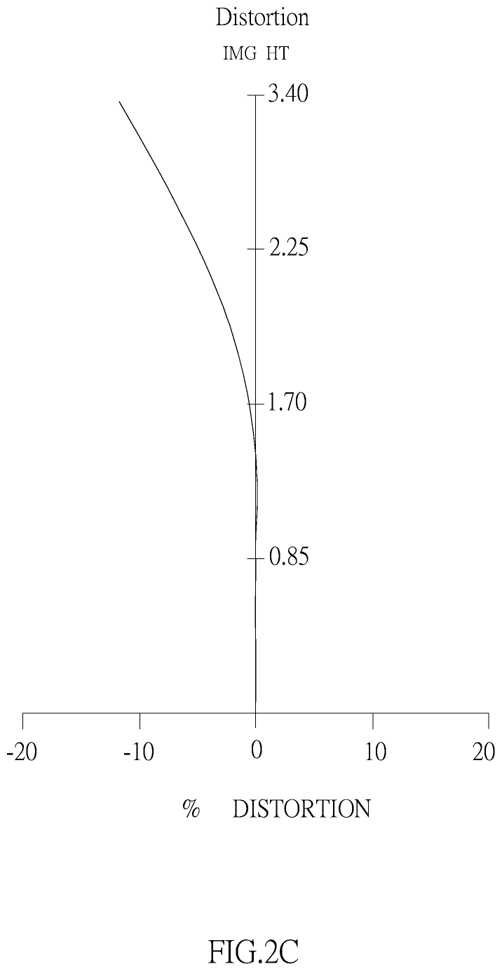

An optical imaging lens 200 according to a second embodiment of the present invention is illustrated in FIG. 2A, which includes, in order along an optical axis Z from an object side to an image side, a first lens assembly G1, an aperture ST, and a second lens assembly G2. In the current embodiment, the first lens assembly G1 has negative refractive power and includes, in order along an optical axis Z from an object side to an image side, a first lens L1, a second lens L2, and a third lens L3; the second lens assembly G2 has positive refractive power and includes, in order along an optical axis Z from an object side to an image side, a fourth lens L4, a fifth lens L5, and a sixth lens L6.

The first lens L1 is a negative meniscus with negative refractive power, wherein an object-side surface S1 of the first lens L1 is a convex surface toward the object side, and an image-side surface S2 of the first lens L1 is a concave surface toward the image side. As shown in FIG. 2A, both of the object-side surface S1 and the image-side surface S2 of the first lens L1 are spherical surfaces; a surface of the first lens L1 toward the object side is entirely convex to form the object-side surface S1, and a part of a surface of the first lens L1 toward the image side is recessed to form the image-side surface S2, and the optical axis Z passes through the object-side surface S1 and the image-side surface S2 of the first lens L1.

The second lens L2 is a negative meniscus with negative refractive power, wherein an object-side surface S3 of the second lens L2 is a convex surface toward the object side, and an image-side surface S4 of the second lens L2 is a concave surface toward the image side; the object-side surface S3, the image-side surface S4, or both of the object-side surface S3 and the image-side surface S4 of the second lens L2 are aspheric surfaces. As shown in FIG. 2A, both of the object-side surface S3 and the image-side surface S4 of the second lens L2 are aspheric surfaces; a surface of the second lens L2 toward the object side is entirely convex to form the object-side surface S3, and a part of a surface of the second lens L2 toward the image side is recessed to form the image-side surface S4, and the optical axis Z passes through the object-side surface S3 and the image-side surface S4 of the second lens L2.

The third lens L3 is a positive meniscus with positive refractive power, wherein an object-side surface S5 of the third lens L3 is a convex surface toward the object side, and an image-side surface S6 of the third lens L3 is a concave surface toward the image side; the object-side surface S5, the image-side surface S6, or both of the object-side surface S5 and the image-side surface S6 of the third lens L3 are aspheric surfaces. As shown in FIG. 2A, both of the object-side surface S5 and the image-side surface S6 of the third lens L3 are aspheric surfaces; a surface of the third lens L3 toward the object side is entirely convex to form the object-side surface S5, and a part of a surface of the third lens L3 toward the image side is recessed to form the image-side surface S6, and the optical axis Z passes through the object-side surface S5 and the image-side surface S6 of the third lens L3.

The fourth lens L4 is a biconvex lens (i.e., both of an object-side surface S7 of the fourth lens L4 and an image-side surface S8 of the fourth lens L4 are convex surfaces). As shown in FIG. 2A, a part of a surface of the fourth lens L4 toward the object side is convex to form the object-side surface S7, and a surface of the fourth lens L4 toward the image side is entirely convex to form the image-side surface S8, and the optical axis Z passes through the object-side surface S7 and the image-side surface S8 of the fourth lens L4.

The fifth lens L5 is a biconcave lens (i.e., both of an object-side surface S9 of the fifth lens L5 and an image-side surface S10 of the fifth lens L5 are concave surfaces) with negative refractive power; the object-side surface S9, the image-side surface S10, or both of the object-side surface S9 and the image-side surface S10 of the fifth lens L5 are aspheric surfaces. As shown in FIG. 2A, both of the object-side surface S9 and the image-side surface S10 of the fifth lens L5 are aspheric surfaces; a part of a surface of the fifth lens L5 toward the object side is recessed to form the object-side surface S9, and a part of a surface of the fifth lens L5 toward the image side is recessed to form the image-side surface S10, and the optical axis Z passes through the object-side surface S9 and the image-side surface S10 of the fifth lens L5.

The sixth lens L6 is a biconvex lens (i.e., both of an object-side surface S11 of the sixth lens L6 and an image-side surface S12 of the sixth lens L6 are convex surfaces) with positive refractive power; the object-side surface S11, the image-side surface S12, or both of the object-side surface S11 and the image-side surface S12 of the sixth lens L6 are aspheric surfaces. As shown in FIG. 2A, both of the object-side surface S11 and the image-side surface S12 of the sixth lens L6 are aspheric surfaces; a part of a surface of the sixth lens L6 toward the object side is convex to form the object-side surface S11, and a part of a surface of the sixth lens L6 toward the image side is convex to form the image-side surface S12 with two inflection points, and the optical axis Z passes through the object-side surface S11 and the image-side surface S12 of the sixth lens L6.

Additionally, the optical imaging lens 200 further includes an infrared filter L7 disposed between the sixth lens L6 and an image plane Im of the optical imaging lens 200 and is closer to the image plane Im than the image-side surface S12 of the sixth lens L6, thereby filtering out excess infrared rays in an image light passing through the optical imaging lens 200 to improve imaging quality.

In order to keep the optical imaging lens 200 in good optical performance and high imaging quality, the optical imaging lens 200 further satisfies:

−0.25≤F/f1≤−0.09; −0.65<F/f2≤−0.3; 0.1≤F/f3≤0.35; (1)

−0.6≤F/fg1≤−0.3; (2)

0.1≤fg1/f1≤0.5; 0.5≤fg1/f2≤1.5; −0.7≤fg1/f3≤−0.2; (3)

0.3≤F/f4≤0.65; −0.56≤F/f5≤−0.25; 0.3≤F/f6≤3.7; (4)

0.25≤F/fg2≤0.57; (5)

0.5≤fg2/f4≤1.2; −1.4≤fg2/f5≤−0.5; 0.7≤fg2/f6≤1.3; (6)

0.5≤|fg2/fg1|≤2.5; (7)

nd4≤1.65; |V4−V5|≥60; 0.9≥|f4/L4R2|≤2; (8)

−27≤HFoV/fg1≤−12; 10≤HFoV/fg2≤17; (9)

wherein F is a focal length of the optical imaging lens 100; f1 is a focal length of the first lens L1; f2 is a focal length of the second lens L2; f3 is a focal length of the third lens L3; f4 is a focal length of the fourth lens L4; f5 is a focal length of the fifth lens L5; f6 is a focal length of the sixth lens L6; fg1 is a focal length of the first lens assembly G1; fg2 is a focal length of the second lens assembly G2; nd4 is a refractive index of the fourth lens L4; V4 is an Abbe number of the fourth lens L4; V5 is an Abbe number of the fifth lens L5; L4R2 is a radius of curvature of the image-side surface S8 of the fourth lens L4.

Parameters of the optical imaging lens 200 of the second embodiment of the present invention are listed in following Table 4, including the focal length F of the optical imaging lens 200 (also called an effective focal length (EFL)), a F-number (Fno), a maximal field of view (HFOV), a radius of curvature (R) of each lens, a distance (D) between each surface and the next surface on the optical axis Z, a refractive index (Nd) of each lens, an Abbe number (Vd) of each lens, the focal length of each lens, wherein a unit of the focal length, the radius of curvature, and the distance is millimeter (mm).

TABLE 4
F = 2.1 mm; Fno = 2.05; HFOV = 60 deg

| | | | | | | Cemented | |
|---|---|---|---|---|---|---|---|
| | | | | | Focal | focal | |
| Surface | R(mm) | D(mm) | Nd | Vd | length | length | Note |
| S1 | 18.77 | 1.72 | 1.63 | 59.18 | −12.70 | 18.77 | L1 |
| S2 | 5.40 | 2.76 | | | | 5.40 | |
| S3 | 8.98 | 1.50 | 1.53 | 56.28 | −4.61 | 8.98 | L2 |
| S4 | 1.80 | 2.24 | | | | 1.80 | |
| S5 | 4.10 | 4.92 | 1.64 | 23.53 | 9.62 | 4.10 | L3 |
| S6 | 6.41 | 1.01 | | | | 6.41 | |
| ST | | −0.05 | | | | | ST |
| S7 | 5.71 | 2.77 | 1.59 | 61.85 | 3.88 | 5.71 | L4 |
| S8 | −3.17 | 0.15 | | | | −3.17 | |
| S9 | −19.92 | 1.30 | 1.64 | 23.53 | −4.73 | −19.92 | L5 |
| S10 | 3.69 | 0.37 | | | | 3.69 | |
| S11 | 3.42 | 3.39 | 1.53 | 56.28 | 4.33 | 3.42 | L6 |
| S12 | −4.51 | 2.60 | | | | −4.51 | |
| S13 | Infinity | 0.30 | 1.52 | 64.17 | | Infinity | Infrared |
| | | | | | | | filter L7 |
| S14 | Infinity | 0.00 | | | | Infinity | |
| Im | Infinity | | | | | Infinity | Im |

It can be seen from Table 4 that, in the second embodiment, the focal length (F) of the optical imaging lens 200 is 2.1 mm, and the Fno is 2.05, and the HFOV is 60 degrees, wherein f1=−12.70 mm; f2=−4.61 mm; f3=9.62 mm; f4=3.88 mm; L4R2=−3.17 mm; nd4=1.59; V4=61.85; f5=−4.73 mm; V5=23.53; f6=4.33 mm; fg1=−3.87 mm; fg2=4.51 mm.

Additionally, based on the above detailed parameters, detailed values of the aforementioned conditional formula in the second embodiment are as follows:

F/f1=−0.17; F/f2=−0.46; F/f3=0.22; (1)

F/fg1=−0.54; (2)

fg1/f1=0.3; fg1/f2=0.84; fg1/f3=−0.4; (3)

F/f4=0.54; F/f5=−0.44; F/f6=0.48; (4)

F/fg2=0.47; (5)

fg2/f4=1.16; fg2/f5=−0.95; fg2/f6=1.04; (6)

|fg2/fg1|=0.87; (7)

nd4=1.59; |V4−V5|=38.32; |f4/L4R2|=1.22; (8)

HFoV/fg1=−15.51; HFoV/fg2=13.3. (9)

With the aforementioned design, the first lens assembly G1 and the second lens assembly G2 satisfy the aforementioned conditions (1) to (9) of the optical imaging lens 200.

Moreover, an aspheric surface contour shape Z of each of the object-side surface S3 of the second lens L2, and the image-side surface S4 of the second lens L2, and the object-side surface S5 of the third lens L3, and the image-side surface S6 of the third lens L3, and the object-side surface S9 of the fifth lens L5, and the image-side surface S10 of the fifth lens L5, and the object-side surface 11 of the sixth lens L6, and the image-side surface S12 of the sixth lens L6 of the optical imaging lens 200 according to the second embodiment could be obtained by following formula:

$$Z = \frac{{ch}^{2}}{1 + \sqrt{1 - ( 1 + k ) {c}^{2} {h}^{2}}} + {A}_{4} {h}^{4} + {A}_{6} {h}^{6} + {A}_{8} {h}^{8} + {A}_{10} {h}^{10} + {A}_{12} {h}^{12} + {A}_{14} {h}^{14} + {A}_{16} {h}^{16}$$

wherein Z is aspheric surface contour shape; c is reciprocal of radius of curvature; h is half the off-axis height of the surface; k is conic constant; A4, A6, A8, A10, A12, A14, and A16 respectively represents different order coefficient of h.

The conic constant k of each of the object-side surface S3 of the second lens L2, and the image-side surface S4 of the second lens L2, and the object-side surface S5 of the third lens L3, and the image-side surface S6 of the third lens L3, and the object-side surface S9 of the fifth lens L5, and the image-side surface S10 of the fifth lens L5, and the object-side surface S11 of the sixth lens L6, and the image-side surface S12 of the sixth lens L6 of the optical imaging lens 200 according to the second embodiment and the different order coefficient of A4, A6, A8, A10, A12, A14, and A16 are listed in following Table 5 and Table 6:

TABLE 5

| Surface | S3 | S4 | S5 | S6 |
|---|---|---|---|---|
| k | −3.68E+01 | −1.38E+00 | −8.58E−01 | 1.13E+01 |
| A4 | 5.36E−03 | 6.34E−03 | −4.20E−04 | 2.61E−04 |
| A6 | −4.60E−04 | 1.57E−03 | 5.76E−04 | −3.31E−04 |
| A8 | 2.29E−05 | −5.73E−04 | −1.30E−04 | 1.27E−03 |
| A10 | −6.67E−07 | 7.36E−05 | 1.76E−05 | −1.12E−03 |
| A12 | 1.07E−08 | −4.37E−06 | −1.09E−06 | 4.24E−04 |
| A14 | −7.98E−11 | 9.79E−08 | 2.64E−08 | −6.23E−05 |
| A16 | 0 | 0 | 0 | 0 |

TABLE 6

| Surface | S9 | S10 | S11 | S12 |
|---|---|---|---|---|
| k | 7.86E+01 | −1.30E+01 | −9.68E+00 | −1.02E+00 |
| A4 | −1.27E−02 | −1.30E−03 | 2.65E−03 | 1.23E−03 |
| A6 | 1.77E−03 | −8.36E−04 | −1.35E−03 | −1.66E−04 |
| A8 | −6.22E−04 | 5.07E−04 | 3.88E−04 | 2.94E−05 |
| A10 | 1.56E−04 | −1.05E−04 | −4.78E−05 | −6.01E−06 |
| A12 | −3.28E−05 | 9.16E−06 | 2.88E−06 | 9.49E−07 |
| A14 | 2.68E−06 | −3.09E−07 | −7.04E−08 | −4.12E−08 |
| A16 | 0 | 0 | 0 | 0 |

Taking optical simulation data to verify the imaging quality of the optical imaging lens 200, wherein FIG. 2B is a diagram showing the astigmatic field curves according to the second embodiment; FIG. 2C is a diagram showing the distortion according to the second embodiment. The graphics shown in FIG. 2B and FIG. 2C are within a standard range. In this way, the optical imaging lens 200 of the second embodiment could effectively enhance image quality and lower a distortion thereof.

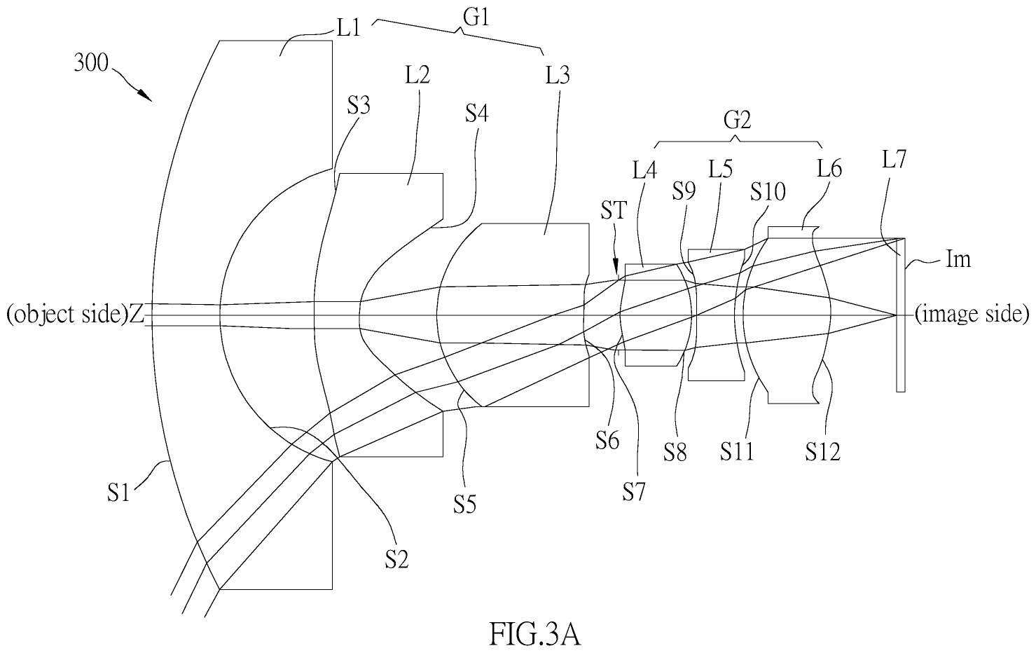

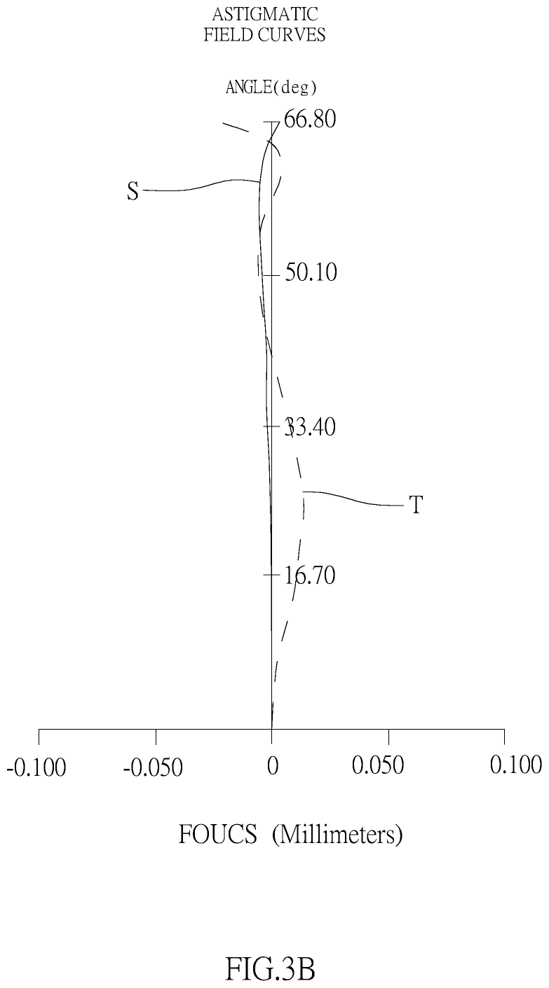

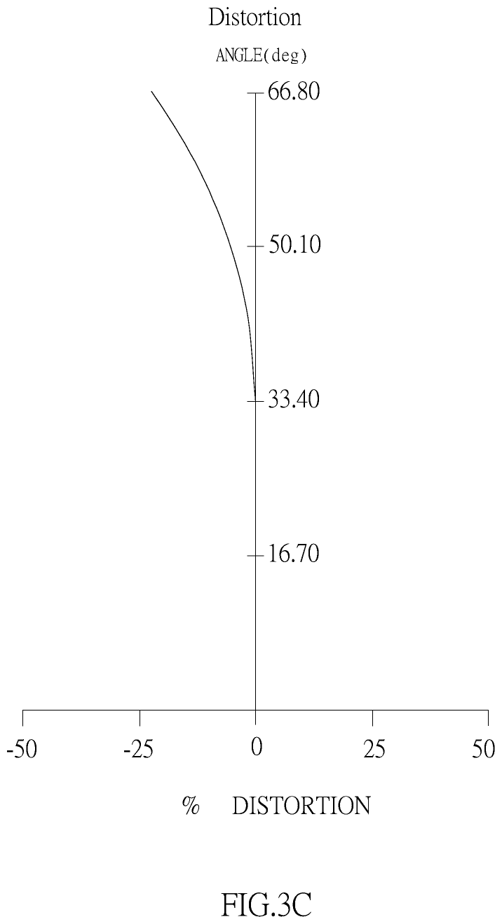

An optical imaging lens 300 according to a third embodiment of the present invention is illustrated in FIG. 3A, which includes, in order along an optical axis Z from an object side to an image side, a first lens assembly G1, an aperture ST, and a second lens assembly G2. In the current embodiment, the first lens assembly G1 has negative refractive power and includes, in order along an optical axis Z from an object side to an image side, a first lens L1, a second lens L2, and a third lens L3; the second lens assembly G2 has positive refractive power and includes, in order along an optical axis Z from an object side to an image side, a fourth lens L4, a fifth lens L5, and a sixth lens L6.

The first lens L1 is a negative meniscus with negative refractive power, wherein an object-side surface S1 of the first lens L1 is a convex surface toward the object side, and an image-side surface S2 of the first lens L1 is a concave surface toward the image side. As shown in FIG. 3A, both of the object-side surface Si and the image-side surface S2 of the first lens L1 are spherical surfaces; a surface of the first lens L1 toward the object side is entirely convex to form the object-side surface S1, and a part of a surface of the first lens L1 toward the image side is recessed to form the image-side surface S2, and the optical axis Z passes through the object-side surface S1 and the image-side surface S2 of the first lens L1.

The second lens L2 is a negative meniscus with negative refractive power, wherein an object-side surface S3 of the second lens L2 is a convex surface toward the object side, and an image-side surface S4 of the second lens L2 is a concave surface toward the image side; the object-side surface S3, the image-side surface S4, or both of the object-side surface S3 and the image-side surface S4 of the second lens L2 are aspheric surfaces. As shown in FIG. 3A, both of the object-side surface S3 and the image-side surface S4 of the second lens L2 are aspheric surfaces; a surface of the second lens L2 toward the object side is entirely convex to form the object-side surface S3, and a part of a surface of the second lens L2 toward the image side is recessed to form the image-side surface S4, and the optical axis Z passes through the object-side surface S3 and the image-side surface S4 of the second lens L2.

The third lens L3 is a positive meniscus with positive refractive power, wherein an object-side surface S5 of the third lens L3 is a convex surface toward the object side, and an image-side surface S6 of the third lens L3 is a concave surface toward the image side; the object-side surface S5, the image-side surface S6, or both of the object-side surface S5 and the image-side surface S6 of the third lens L3 are aspheric surfaces. As shown in FIG. 3A, both of the object-side surface S5 and the image-side surface S6 of the third lens L3 are aspheric surfaces; a surface of the third lens L3 toward the object side is entirely convex to form the object-side surface S5, and a part of a surface of the third lens L3 toward the image side is recessed to form the image-side surface S6, and the optical axis Z passes through the object-side surface S5 and the image-side surface S6 of the third lens L3.

The fourth lens L4 is a biconvex lens (i.e., both of an object-side surface S7 of the fourth lens L4 and an image-side surface S8 of the fourth lens L4 are convex surfaces) with positive refractive power. As shown in FIG. 3A, a part of a surface of the fourth lens L4 toward the object side is convex to form the object-side surface S7, and a surface of the fourth lens L4 toward the image side is entirely convex to form the image-side surface S8, and the optical axis Z passes through the object-side surface S7 and the image-side surface S8 of the fourth lens L4.

The fifth lens L5 is a biconcave lens (i.e., both of an object-side surface S9 of the fifth lens L5 and an image-side surface S10 of the fifth lens L5 are concave surfaces) with negative refractive power; the object-side surface S9, the image-side surface S10, or both of the object-side surface S9 and the image-side surface S10 of the fifth lens L5 are aspheric surfaces. As shown in FIG. 3A, both of the object-side surface S9 and the image-side surface S10 of the fifth lens L5 are aspheric surfaces; a part of a surface of the fifth lens L5 toward the object side is recessed to form the object-side surface S9, and a part of a surface of the fifth lens L5 toward the image side is recessed to form the image-side surface S10, and the optical axis Z passes through the object-side surface S9 and the image-side surface S10 of the fifth lens L5.

The sixth lens L6 is a biconvex lens (i.e., both of an object-side surface S11 of the sixth lens L6 and an image-side surface S12 of the sixth lens L6 are convex surfaces) with positive refractive power; the object-side surface S11, the image-side surface S12, or both of the object-side surface S11 and the image-side surface S12 of the sixth lens L6 are aspheric surfaces. As shown in FIG. 3A, both of the object-side surface S11 and the image-side surface S12 of the sixth lens L6 are aspheric surfaces; a part of a surface of the sixth lens L6 toward the object side is convex to form the object-side surface S11, and a part of a surface of the sixth lens L6 toward the image side is convex to form the image-side surface S12 with two inflection points, and the optical axis Z passes through the object-side surface S11 and the image-side surface S12 of the sixth lens L6.

Additionally, the optical imaging lens 300 further includes an infrared filter L7 disposed between the sixth lens L6 and an image plane Im of the optical imaging lens 300 and is closer to the image plane Im than the image-side surface S12 of the sixth lens L6, thereby filtering out excess infrared rays in an image light passing through the optical imaging lens 300 to improve imaging quality.

In order to keep the optical imaging lens 300 in good optical performance and high imaging quality, the optical imaging lens 300 further satisfies:

−0.25≤F/f1≤−0.09; −0.65≤F/f2≤−0.3; 0.1≤F/f3≤0.35; (1)

−0.6≤F/fg1≤−0.3; (2)

0.1≤fg1/f1≤0.5; 0.5≤fg1/f2≤1.5; −0.7≤fg1/f3≤−0.2; (3)

0.3≤F/f4<0.65; −0.56≤F/f5≤−0.25; 0.3≤F/f6≤0.7; (4)

0.25≤F/fg2≤0.57; (5)

0.5≤fg2/f4≤1.2; −1.4≤fg2/f5≤−0.5; 0.7≤fg2/f6≤1.3; (6)

0.5≤fg2/fg1|≤2.5; (7)

nd4≤1.65; |V4−V5|≤60; 0.9≤|f4/L4R2|≤2; (8)

−27≤HFoV/fg1≤−12; 10≤HFoV/fg2≤17; (9)

wherein F is a focal length of the optical imaging lens 300; f1 is a focal length of the first lens L1; f2 is a focal length of the second lens L2; f3 is a focal length of the third lens L3; f4 is a focal length of the fourth lens L4; f5 is a focal length of the fifth lens L5; f6 is a focal length of the sixth lens L6; l fg1 is a focal length of the first lens assembly G1; fg2 is a focal length of the second lens assembly G2; nd4 is a refractive index of the fourth lens L4; V4 is an Abbe number of the fourth lens L4; V5 is an Abbe number of the fifth lens L5; L4R2 is a radius of curvature of the image-side surface S8 of the fourth lens L4.

Parameters of the optical imaging lens 300 of the third embodiment of the present invention are listed in following Table 7, including the focal length F of the optical imaging lens 300 (also called an effective focal length (EFL)), a F-number (Fno), a maximal field of view (HFOV), a radius of curvature (R) of each lens, a distance (D) between each surface and the next surface on the optical axis Z, a refractive index (Nd) of each lens, an Abbe number (Vd) of each lens, the focal length of each lens, wherein a unit of the focal length, the radius of curvature, and the distance is millimeter (mm).

TABLE 7
F = 1.59 mm; Fno = 1.9; HFOV = 65 deg

| | | | | | | Cemented | |
|---|---|---|---|---|---|---|---|
| | | | | | Focal | focal | |
| Surface | R(mm) | D(mm) | Nd | Vd | length | length | Note |
| S1 | 21.50 | 2.35 | 1.62 | 60.32 | −12.27 | 21.50 | L1 |
| S2 | 5.40 | 3.26 | | | | 5.40 | |
| S3 | 14.00 | 1.50 | 1.53 | 56.46 | −4.09 | 14.00 | L2 |
| S4 | 1.80 | 2.76 | | | | 1.80 | |
| S5 | 4.34 | 5.00 | 1.64 | 23.52 | 9.95 | 4.34 | L3 |
| S6 | 7.36 | 1.25 | | | | 7.36 | |
| ST | Infinity | 0.06 | | | | Infinity | ST |
| S7 | 5.50 | 2.45 | 1.57 | 63.04 | 3.85 | 5.50 | L4 |
| S8 | −3.10 | 0.15 | | | | −3.10 | |
| S9 | −16.76 | 1.30 | 1.64 | 23.52 | −4.21 | −16.76 | L5 |
| S10 | 3.33 | 0.30 | | | | 3.33 | |
| S11 | 2.92 | 3.01 | 1.53 | 56.46 | 3.76 | 2.92 | L6 |
| S12 | −3.97 | 0.30 | | | | −3.97 | |
| S13 | Infinity | 0.30 | 1.52 | 64.17 | | Infinity | Infrared |
| | | | | | | | filter L7 |
| S14 | Infinity | 2.02 | | | | Infinity | |
| Im | Infinity | | | | | Infinity | Im |

It can be seen from Table 7 that, in the current embodiment, the focal length F of the optical imaging lens 300 is 1.59 mm, and the Fno is 1.9, and the HFOV is 65 degrees, wherein f1=−12.27 mm; f2=−4.09 mm; f3=9.95 mm; f4=3.85 mm; L4R2=−3.10 mm; nd4=1.57; V4=63.04; f5=−4.21 mm; V5=23.52; f6=3.76 mm; fg1=−3.67 mm; fg2=4.23 mm.

Additionally, based on the above detailed parameters, detailed values of the aforementioned conditional formula in the third embodiment are as follows:

F/f1=−0.13; F/f2=−0.39; F/f3=0.16; (1)

F/fg1=−0.43; (2)

fg1/f1=0.3; fg1/f2=0.9; fg1/f3=−0.37; (3)

F/f4=0.41; F/f5=−0.38; F/f6=0.42; (4)

F/fg2=0.38; (5)

fg2/f4=1.1; fg2/f5=−1; fg2/f6=1.13; (6)

|fg2/fg1|=1.15; (7)

nd4=1.57; |V4−V5|=39.52; |f4/L4R2|=1.24; (8)

HFoV/fg1=−17.72; HFoV/fg2=15.36. (9)

With the aforementioned design, the first lens assembly G1 and the second lens assembly G2 satisfy the aforementioned conditions (1) to (9) of the optical imaging lens 300.

Moreover, an aspheric surface contour shape Z of each of the object-side surface S3 of the second lens L2, and the image-side surface S4 of the second lens L2, and the object-side surface S5 of the third lens L3, and the image-side surface S6 of the third lens L3, and the object-side surface S9 of the fifth lens L5, and the image-side surface S10 of the fifth lens L5, and the object-side surface S11 of the sixth lens L6, and the image-side surface S12 of the sixth lens L6 of the optical imaging lens 300 according to the third embodiment could be obtained by following formula:

$$Z = \frac{{ch}^{2}}{1 + \sqrt{1 - ( 1 + k ) {c}^{2} {h}^{2}}} + {A}_{4} {h}^{4} + {A}_{6} {h}^{6} + {A}_{8} {h}^{8} + {A}_{10} {h}^{10} + {A}_{12} {h}^{12} + {A}_{14} {h}^{14} + {A}_{16} {h}^{16}$$

wherein Z is aspheric surface contour shape; c is reciprocal of radius of curvature; h is half the off-axis height of the surface; k is conic constant; A4, A6, A8, A10, A12, A14, and A16 respectively represents different order coefficient of h.

The conic constant k of each of the object-side surface S3 of the second lens L2, and the image-side surface S4 of the second lens L2, and the object-side surface S5 of the third lens L3, and the image-side surface S6 of the third lens L3, and the object-side surface S9 of the fifth lens L5, and the image-side surface S10 of the fifth lens L5, and the object-side surface S11 of the sixth lens L6, and the image-side surface S12 of the sixth lens L6 of the optical imaging lens 300 according to the third embodiment and the different order coefficient of A4, A6, A8, A10, A12, A14, and A16 are listed in following Table 8 and Table 9:

TABLE 8

| Surface | S3 | S4 | S5 | S6 |
|---|---|---|---|---|
| k | −9.00E+01 | −1.33E+00 | −7.59E−01 | 1.55E+01 |
| A4 | 5.11E−03 | 6.11E−03 | −3.27E−04 | 1.90E−03 |
| A6 | −4.72E−04 | 1.52E−03 | 6.46E−04 | −2.95E−04 |
| A8 | 2.30E−05 | −5.77E−04 | −1.31E−04 | 1.51E−03 |
| A10 | −6.62E−07 | 7.35E−05 | 1.71E−05 | −1.16E−03 |
| A12 | 1.07E−08 | −4.34E−06 | −1.08E−06 | 4.24E−04 |
| A14 | −7.74E−11 | 9.79E−08 | 2.64E−08 | −6.23E−05 |
| A16 | 0 | 0 | 0 | 0 |

TABBLE 9

| Surface | S9 | S10 | S11 | S12 |
|---|---|---|---|---|
| k | 5.74E+01 | −1.10E+01 | −7.22E+00 | −2.59E+00 |
| A4 | −1.36E−02 | −1.24E−03 | 3.74E−03 | 1.65E−03 |
| A6 | 1.67E−03 | −1.04E−03 | −1.28E−03 | −3.17E−04 |
| A8 | −7.32E−04 | 4.88E−04 | 3.88E−04 | 3.82E−05 |
| A10 | 1.65E−04 | −1.04E−04 | −4.75E−05 | −3.27E−07 |
| A12 | −3.28E−05 | 9.16E−06 | 2.89E−06 | 9.49E−07 |
| A14 | 2.68E−06 | −3.09E−07 | −7.04E−08 | −4.12E−08 |
| A16 | 0 | 0 | 0 | 0 |

Taking optical simulation data to verify the imaging quality of the optical imaging lens 300, wherein FIG. 3B is a diagram showing the astigmatic field curves according to the third embodiment; FIG. 3C is a diagram showing the distortion according to the third embodiment. The graphics shown in FIG. 3B and FIG. 3C are within a standard range. In this way, the optical imaging lens 300 of the third embodiment could effectively enhance image quality and lower a distortion thereof.

It must be pointed out that the embodiments described above are only some preferred embodiments of the present invention. It is noted that, the parameters listed in Tables are not a limitation of the present invention. All equivalent structures which employ the concepts disclosed in this specification and the appended claims should fall within the scope of the present invention.

What is claimed is:

1. An optical imaging lens, in order from an object side to an image side along an optical axis, comprising:
a first lens assembly having negative refractive power and comprising, in order along the optical axis from the object side to the image side, a first lens, a second lens, and a third lens, wherein the first lens has negative refractive power; the second lens has negative refractive power; an object-side surface, an image-side surface, or both of the object-side surface and the image-side surface of the second lens are aspheric surfaces; the third lens has positive refractive power; an object-side surface, an image-side surface, or both of the object-side surface and the image-side surface of the third lens are aspheric surfaces;
an aperture;
a second lens assembly having positive refractive power and comprising, in order along the optical axis from the object side to the image side, a fourth lens, a fifth lens, and a sixth lens, wherein the fourth lens has positive refractive power; the fifth lens has negative refractive power; an object-side surface, an image-side surface, or both of the object-side surface and the image-side surface of the fifth lens are aspheric surfaces; the sixth lens has positive refractive power; an object-side surface, an image-side surface, or both of the object-side surface and the image-side surface of the sixth lens are aspheric surfaces; and
wherein the optical imaging lens satisfies: −0.6≤F/fg1≤−0.3; F is a focal length of the optical imaging lens and fg1 is a focal length of the first lens assembly.

2. The optical imaging lens as claimed in claim 1, wherein the optical imaging lens satisfies: −0.25≤F/f1≤−0.09, wherein f1 is a focal length of the first lens.

3. The optical imaging lens as claimed in claim 2, wherein the optical imaging lens satisfies: 0.1≤fg1/f1≤0.5.

4. The optical imaging lens as claimed in claim 1, wherein the optical imaging lens satisfies: −0.65≤F/f2≤−0.3, wherein f2 is a focal length of the second lens.

5. The optical imaging lens as claimed in claim 4, wherein the optical imaging lens satisfies: 0.5≤fg1/f2≤1.5.

6. The optical imaging lens as claimed in claim 1, wherein the optical imaging lens satisfies: 0.1≤F/f3≤0.35, wherein f3 is a focal length of the third lens.

7. The optical imaging lens as claimed in claim 6, wherein the optical imaging lens satisfies: −0.7≤fg1/f3≤−0.2.

8. The optical imaging lens as claimed in claim 1, wherein the optical imaging lens satisfies: 0.3≤F/f4≤0.65, wherein f4 is a focal length of the fourth lens.

9. The optical imaging lens as claimed in claim 1, wherein the optical imaging lens satisfies: −0.56≤F/f5≤−0.25, wherein f5 is a focal length of the fifth lens.

10. The optical imaging lens as claimed in claims 1, wherein the optical imaging lens satisfies: 0.3≤F/f6≤0.7, wherein f6 is a focal length of the sixth lens.

11. The optical imaging lens as claimed in claims 1, wherein the optical imaging lens satisfies: nd4≤1.65; nd4 is a refractive index of the fourth lens.

12. The optical imaging lens as claimed in claims 1, wherein the optical imaging lens satisfies: |V4−V5|≤60; V4 is an Abbe number of the fourth lens; V5 is an Abbe number of the fifth lens.

13. The optical imaging lens as claimed in claims 1, wherein the optical imaging lens satisfies: 0.5≤|fg2/fg1|≤2.5; fg2 is a focal length of the second lens assembly.

14. The optical imaging lens as claimed in claims 1, wherein the optical imaging lens satisfies: 0.9≤|f4/L4R2|≤2; f4 is a focal length of the fourth lens; L4R2 is a radius of curvature of the image-side surface of the fourth lens.

15. The optical imaging lens as claimed in claims 1, wherein the optical imaging lens satisfies: −27≤HFoV/fg1≤−12 and 10≤HFoV/fg2≤17; HFoV is a maximal field of view of the optical imaging lens; fg2 is a focal length of the second lens assembly.

16. The optical imaging lens as claimed in claims 1, wherein both of the object-side surface and the image-side surface of the second lens are aspheric surfaces.

17. The optical imaging lens as claimed in claims 1, wherein both of the object-side surface and the image-side surface of the third lens are aspheric surfaces.

18. The optical imaging lens as claimed in claims 1, wherein both of the object-side surface and the image-side surface of the fifth lens are aspheric surfaces.

19. The optical imaging lens as claimed in claims 1, wherein both of the object-side surface and the image-side surface of the sixth lens are aspheric surfaces.

20. An optical imaging lens, in order from an object side to an image side along an optical axis, comprising:
a first lens assembly having negative refractive power and comprising, in order along the optical axis from the object side to the image side, a first lens, a second lens, and a third lens, wherein the first lens has negative refractive power; the second lens has negative refractive power; an object-side surface, an image-side surface, or both of the object-side surface and the image-side surface of the second lens are aspheric surfaces; the third lens has positive refractive power; an object-side surface, an image-side surface, or both of the object-side surface and the image-side surface of the third lens are aspheric surfaces;
an aperture;
a second lens assembly having positive refractive power and comprising, in order along the optical axis from the object side to the image side, a fourth lens, a fifth lens, and a sixth lens, wherein the fourth lens has positive refractive power; the fifth lens has negative refractive power; an object-side surface, an image-side surface, or both of the object-side surface and the image-side surface of the fifth lens are aspheric surfaces; the sixth lens has positive refractive power; an object-side surface, an image-side surface, or both of the object-side surface and the image-side surface of the sixth lens are aspheric surfaces; and
wherein the optical imaging lens satisfies: 0.25≤F/fg2≤0.57; F is a focal length of the optical imaging lens and fg2 is a focal length of the second lens assembly.

21. The optical imaging lens as claimed in claim 20, wherein the optical imaging lens satisfies: −0.25≤F/f1≤−0.09, wherein f1 is a focal length of the first lens.

22. The optical imaging lens as claimed in claim 20, wherein the optical imaging lens satisfies: −0.65≤F/f2≤−0.3, wherein f2 is a focal length of the second lens.

23. The optical imaging lens as claimed in claim 20, wherein the optical imaging lens satisfies: 0.1≤F/f3≤0.35, wherein f3 is a focal length of the third lens.

24. The optical imaging lens as claimed in claim 20, wherein the optical imaging lens satisfies: 0.3≤F/f4≤0.65, wherein f4 is a focal length of the fourth lens.

25. The optical imaging lens as claimed in claim 24, wherein the optical imaging lens satisfies: 0.5≤fg2/f4≤1.2.

26. The optical imaging lens as claimed in claim 20, wherein the optical imaging lens satisfies: −0.56≤F/f5≤−0.25, wherein f5 is a focal length of the fifth lens.

27. The optical imaging lens as claimed in claim 26, wherein the optical imaging lens satisfies: −1≤fg2/f5≤−0.5.

28. The optical imaging lens as claimed in claim 20, wherein the optical imaging lens satisfies: 0.3≤F/f6≤0.7, wherein f6 is a focal length of the sixth lens.

29. The optical imaging lens as claimed in claim 28, wherein the optical imaging lens satisfies: 0.7≤fg2/f6≤1.3.

30. The optical imaging lens as claimed in claims 20, wherein the optical imaging lens satisfies: nd4≤1.65; nd4 is a refractive index of the fourth lens.

31. The optical imaging lens as claimed in claims 20, wherein the optical imaging lens satisfies: |V4−V5|≤60; V4 is an Abbe number of the fourth lens; V5 is an Abbe number of the fifth lens.

32. The optical imaging lens as claimed in claims 20, wherein the optical imaging lens satisfies: 0.5≤|fg2/fg1|≤2.5; fg1 is a focal length of the first lens assembly.

33. The optical imaging lens as claimed in claims 20, wherein the optical imaging lens satisfies: 0.9≤|f4/L4R2|≤2; f4 is a focal length of the fourth lens; L4R2 is a radius of curvature of the image-side surface of the fourth lens.

34. The optical imaging lens as claimed in claims 20, wherein both of the object-side surface and the image-side surface of the second lens are aspheric surfaces.

35. The optical imaging lens as claimed in claims 20, wherein both of the object-side surface and the image-side surface of the third lens are aspheric surfaces.

36. The optical imaging lens as claimed in claims 20, wherein both of the object-side surface and the image-side surface of the fifth lens are aspheric surfaces.

37. The optical imaging lens as claimed in claims 20, wherein both of the object-side surface and the image-side surface of the sixth lens are aspheric surfaces.

38. The optical imaging lens as claimed in claims 20, wherein the optical imaging lens satisfies: −27≤HFoV/fg1≤−12 and 10≤HFoV/fg2≤17; HFoV is a maximal field of view of the optical imaging lens; fg1 is a focal length of the first lens assembly.
